(19) United States
(12) Patent Application Publication
(10) Pub. No.: US 2008/0118738 A1
(43) Pub. Date: May 22, 2008

(54) Microporous materials and multi-layer articles prepared therefrom

(76) Inventors: James L. Boyer, Monroeville, PA (US); Charles R. Coleman, Pittsburgh, PA (US); Narayan K. Raman, Pittsburgh, PA (US); Paul L. Benenati, Wadsworth, OH (US)

Correspondence Address: PPG Industries, Inc.;Law Department - Intellectual Property, 39th Floor, One PPG Place, Pittsburgh, PA, 15272-0001, US

(21) Appl. No.: 11/601,191

(22) Filed: Nov. 17, 2006

(51) Int. Cl. B32B 3/00

(52) U.S. Cl. 428/315.9

(57) ABSTRACT

Described are microporous materials including
(a) a polymeric matrix component;
(b) a finely divided, particulate inorganic filler component dispersed throughout the polymeric matrix; and
(c) a network of interconnecting pores communicating substantially throughout the microporous material, the pores constituting 10 to 80 percent by volume of the microporous material. The polymeric component is based on
   (i) 5 to 100 weight percent based on total weight of component (a) of low melt flow index polypropylene;
   (ii) 0 to 90 weight percent based on total weight of component (a) of ultrahigh molecular weight polyethylene; and
   (iii) 0 to 90 weight percent based on total weight of component (a) of high density polyethylene. Also provided are multi-layer articles prepared from the microporous materials.

### FIELD OF THE INVENTION

The present invention relates to multi-component microporous materials and to multi-layer articles comprising such materials.

### BACKGROUND OF THE INVENTION

In recent years synthetic papers have been developed for use in the printing and labeling industries. Synthetic papers offer significant advantages over natural wood pulp paper including water resistance, tear resistance, and tensile strength. Such materials are typically made of sheets of polyolefins or polyester. Industry standards demand certain maximum thicknesses, and in order to meet them, manufacturers often compromise rigidity or stiffness of their materials, which can result in processing and handling difficulties, particularly during printing.

Other drawbacks can include poor ink adhesion and extended drying times, as well as poor print quality which may be overcome through the application of coatings to improve ink adhesion and printability. However, such coatings can adversely affect other physical properties of the printable sheet material.

Thus there is a need in the art to develop materials that overcome the drawbacks of the prior art by demonstrating stiffness or rigidity, digital printability, fast drying times, ease of handling, and superior laminating capabilities, while maintaining minimal sheet thickness.

### SUMMARY OF THE INVENTION

In accordance with the present invention, a microporous material is provided, comprising:

(a) a polymeric matrix component;

(b) a finely divided, inorganic filler component dispersed throughout the polymeric matrix; and

(c) a network of interconnecting pores communicating substantially throughout the microporous material, the pores constituting 10 to 80 percent by volume of the microporous material. The polymeric component (a) comprises:
(i) 5 to 100 weight percent based on total weight of component (a) of low melt flow index polypropylene;
(ii) 0 to 90 weight percent based on total weight of component (a) of ultrahigh molecular weight polyethylene; and
(iii) 0 to 90 weight percent based on total weight of component (a) of high density polyethylene. The weight ratio of the filler component (b) to the polymeric matrix component (a) ranges from 0.1 to 10.0.

Also provided are multi-layer articles prepared from the microporous materials.

### DETAILED DESCRIPTION OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The various embodiments and examples of the present invention as presented herein are each understood to be non-limiting with respect to the scope of the invention.

As used in the following description and claims, the following terms have the indicated meanings:

The terms “on”, “appended to”, “affixed to”, “bonded to”, “adhered to”, or terms of like import means that the designated item, e.g., a coating, film or layer, is either directly connected to (superimposed directly on) the object surface, or indirectly connected to the object surface, e.g., through one or more other coatings, films or layers.

The term “rigid”, as used for example in connection with a substrate, means that the specified item is self-supporting, i.e., capable of maintaining its shape and supporting any subsequently applied layers, for example, as may be applied through printing processes.

The term “transparent”, as used for example in connection with a substrate, film, material and/or coating, means that the indicated substrate, coating, film and/or material has the property of transmitting light without appreciable scattering so that objects lying beyond are entirely visible.

The phrase “an at least partial film” means an amount of film covering at least a portion, up to the complete surface of the substrate. As used herein, a “film” may be formed by a sheeting type of material or a coating type of material. For example, a film may be a polymeric sheet or a polymeric coating of the material indicated.

As previously mentioned, a microporous material is provided, comprising:

(a) a polymeric matrix component;

(b) a finely divided, particulate inorganic filler component, such as a filler component comprising siliceous and/or non-siliceous filler materials, dispersed throughout the polymeric matrix; and

(c) a network of interconnecting pores communicating substantially throughout the microporous material, the pores constituting 10 to 80 percent by volume of the microporous material. As used herein, “microporous material” means a material having a network of interconnecting pores, wherein, on a coating-free, printing ink-free, impregnant-free, and pre-bonding basis, the pores have a volume average diameter ranging from 0.02 to 0.5 micrometer, and constitute at least 5 percent by volume of the material. The polymeric component (a) comprises:
(i) 5 to 100 weight percent based on total weight of component (a) of low melt flow index polypropylene;
(ii) 0 to 90 weight percent based on total weight of component (a) of ultrahigh molecular weight polyethylene; and
(iii) 0 to 90 weight percent based on total weight of component (a) of high density polyethylene.
   The polymeric matrix component (a) used in the present invention comprises (i) a low melt flow index polyolefin, such as polyethylene and/or polypropylene. Melt Flow Index is a measure of the mass (typically in grams) of polymer that can be forced through a capillary die of standard dimensions under the action of a standard weight in a set amount of time (typically 10 minutes). By “low melt flow index” is meant that the melt index of the polyolefin, e.g., polypropylene, (i) is less than 100 grams/10 minutes, such as less than 50 grams/10 minutes, or less than 25 grams/10 minutes, or less than 10 grams/10 minutes, or less than 5 grams/10 minutes as determined by ASTM D 1238 at a temperature of 230° C. with a 2.16 kilogram load.

Suitable polypropylenes (i) that may be used in the polymeric matrix (a) include but are not limited to PRO-FAX 6823, PRO-FAX PH382M, and PRO-FAX SC204, all manufactured by Basell Polyolefins, and H605 and H502HC manufactured by Braskem.

The low melt flow index polypropylene (i) can be present in the polymeric matrix component (a) in an amount ranging from 5 to 100 percent by weight, such as from 10 to 90 percent by weight, or from 15 to 80 percent by weight, or from 25 to 75 percent by weight, based on the total weight of component (a).

The polymeric matrix component (a) used in the present invention further comprises (ii) an ultrahigh molecular weight polyethylene (UHMWPE). Because ultrahigh molecular weight polyethylene (UHMWPE) is not a thermoset polymer having an infinite molecular weight, it is technically classified as a thermoplastic. However, because the molecules are very long chains, UHMWPE softens when heated but does not flow. The very long chains and the peculiar properties they provide to UHMWPE are believed to contribute in large measure to the desirable properties of microporous materials made using this polymer.

The intrinsic viscosity of the UHMWPE is at least 10 deciliters/gram, such as at least 14 deciliters/gram, or at least 18 deciliters/gram, or at least 19 deciliters/gram. Although there is no particular restriction on the upper limit of the intrinsic viscosity, the intrinsic viscosity is frequently in the range of from 10 to 39 deciliters/gram, such as from 14 to 39 deciliters/gram, or from 18 to 39 deciliters/gram.

The nominal molecular weight of UHMWPE is empirically related to the intrinsic viscosity of the polymer according to the equation:

M=5.37×10⁴[η]^{1.37}

where M is the nominal molecular weight and [η] is the intrinsic viscosity of the UHMWPE expressed in deciliters/gram.

As used herein and in the claims, intrinsic viscosity is determined by extrapolating to zero concentration the reduced viscosities or the inherent viscosities of several dilute solutions of the UHMWPE where the solvent is freshly distilled decahydronaphthalene to which 0.2 percent by weight, 3,5-di-tert-butyl-4-hydroxyhydrocinnamic acid, neopentanetetrayl ester [CAS Registry No. 6683-19-8] has been added. The reduced viscosities or the inherent viscosities of the UHMWPE are ascertained from relative viscosities obtained at 135° C. using an Ubbelohde No. 1 viscometer in accordance with the general procedures of ASTM D 4020-81, except that several dilute solutions of differing concentration are employed. Suitable UHMWPE (ii) that may be used in the polymeric matrix (a) includes but is not limited to GUR 4130 and GUR 4150 both available from Ticona Engineering Polymers, and UTEC 6540 available from Braskem.

The ultrahigh molecular weight polyethylene (ii) can be present in the polymeric matrix component (a) in an amount ranging from 0 to 90 percent by weight, such as from 5 to 80 percent by weight, or from 10 to 70 percent by weight, or from 15 to 65 percent by weight, based on the total weight of component (a).

The polymeric matrix component (a) used in the present invention may further comprise (iii) a high density polyethylene (HDPE). HDPE typically has a density greater than 0.940 g/cm³, such as from 0.941 to 0.965 g/cm³. Suitable HDPE (iii) that may be used in the polymeric matrix (a) can include but is not limited to FINA® 1288 available commercially from Total Petrochemicals (manufactured by Atofina), and MG-0240 available from Braskem.

The high density polyethylene (iii) can be present in the polymeric matrix component (a) in an amount ranging from 0 to 90 percent by weight, such as from 5 to 80 percent by weight, or from 15 to 65 percent by weight, or from 20 to 50 percent by weight, based on the total weight of component (a).

Sufficient amounts of each of the above-described polyolefins should be present in the matrix to provide their desired properties to the microporous material.

One or more other thermoplastic organic polymers also may be present in the matrix provided the desired properties of the microporous material are not affected in an adverse manner. The amount of the other thermoplastic polymers which may be present depends upon the nature of such polymers, the desired properties and the end-use application for the microporous material. Examples of thermoplastic organic polymers which optionally may be present can include poly(tetrafluoroethylene); copolymers of ethylene and propylene; functionalized polyolefins, such as vinyl acetate and/or vinyl alcohol modified polyethylene, or vinyl acetate and/or vinyl alcohol modified polypropylene, copolymers of ethylene and/or propylene modified with acrylic acid (e.g., POLYBOND 1001, 1002, and 1009 all available from Chemtura), and copolymers of ethylene and/or propylene modified with methacrylic acid, maleic anhydride modified polypropylenes, and maleic anhydride modified polyethylenes (e.g., FUSABOND M-613-05, MD-511 D, MB100D, and MB 439D all available from DuPont de Nemours and Company). If desired, all or a portion of the carboxyl groups of carboxyl-containing copolymers may be neutralized with sodium, zinc, or the like.

The microporous material of the present invention further comprises (b) a finely divided, particulate filler component. The finely divided, particulate filler component may comprise one or more inorganic filler materials, for example, siliceous and non-siliceous materials. The filler component is dispersed throughout the polymeric matrix component substantially homogeneously.

As present in the microporous material, the finely divided particles may be in the form of ultimate particles, aggregates of ultimate particles, or a combination of both. For some applications, at least about 75 percent by weight of the particles used in preparing the microporous material have gross particle sizes in the range of from about 0.1 to about 40 micrometers as measured by light scattering using a LS 230 instrument (manufactured by Beckman Coulter, Inc.). It should be noted that specific ranges can vary from filler to filler. Moreover, it is expected that the sizes of filler agglomerates may be reduced during processing of the ingredients to prepare the microporous material. Accordingly, the distribution of gross particle sizes in the microporous material may be smaller than in the raw filler itself.

The filler component (b) can comprise water-insoluble siliceous materials, metal oxides, and/or metal salts. Examples of suitable siliceous particles include particles of silica, mica, montmorillonite, including montmorillonite nanoclays such as those available from Southern Clay Products under the tradename CLOISITE®, kaolinite, asbestos, talc, diatomaceous earth, vermiculite, natural and synthetic zeolites, cement, calcium silicate, aluminum silicate, sodium aluminum silicate, aluminum polysilicate, alumina silica gels, and glass particles. Silica and the clays are often used. Of the silicas, precipitated silica, silica gel, or fumed silica are most often used. Any of the previously mentioned siliceous particles may include treated (e.g., surface treated or chemically treated) siliceous particles.

In addition to or in place of the siliceous particles, finely divided substantially water-insoluble non-siliceous filler particles may also be employed. Examples of such non-siliceous filler particles include particles of titanium oxide, iron oxide, copper oxide, zinc oxide, antimony oxide, zirconia, magnesium oxide, alumina, molybdenum disulfide, zinc sulfide, barium sulfate, strontium sulfate, calcium carbonate, magnesium carbonate, magnesium hydroxide, and finely divided substantially water-insoluble flame retardant filler particles such as particles of ethylenebis(tetrabromophthalimide), octabromodiphenyl oxide, decabromodiphenyl oxide, and ethylenebisdibromonorbornane dicarboximide.

Many different precipitated silicas may be employed in the present invention, but those obtained by precipitation from an aqueous solution of sodium silicate using a suitable acid such as sulfuric acid, hydrochloric acid, or carbon dioxide are used most often. Such precipitated silicas are themselves known and processes for producing them are described in detail in U.S. Pat. Nos. 2,657,149; 2,940,830; and 4,681,750. Typical precipitated silicas can include those having a BET (five-point) surface area ranging from 20 to 500 m²/gram, such as from 50 to 250 m²/gram, or from 100 to 200 m²/gram.

For some applications, at least 20 percent by weight, such as at least 50 percent by weight, or at least 65 percent by weight, or at least 75 percent by weight, or at least 85 percent by weight, of the finely divided filler component (b) can be finely divided, substantially water-insoluble siliceous filler particles. Also, for some applications, finely divided, substantially water-insoluble siliceous filler particles can comprise 100 percent by weight of the finely divided filler particles present in the filler component (b).

Further, the weight ratio of the filler component (b) to the polymeric matrix component (a) can range from 0.1 to 10, such as from 0.1 to 8.0, or from 0.1 to 5.0, or from 0.1 to 4.0, or from 0.1 to 3.0, or from 0.5 to 3.0.

Minor amounts, usually less than 10 percent by weight, of other materials used in processing such as lubricant, processing plasticizer, organic extraction liquid, surfactant, water, and the like, may also be present. Yet other materials introduced for particular purposes may optionally be present in the microporous material in small amounts, usually less than about 15 percent by weight. Examples of such materials can include antioxidants, ultraviolet light absorbers, reinforcing fibers such as chopped glass fiber strand, dyes, pigments, and the like. The balance of the microporous material, exclusive of filler and any coating, printing ink, or impregnant applied for one or more special purposes is essentially the organic polymer.

As previously mentioned, the microporous material of the present invention comprises (c) a network of interconnecting pores communicating substantially throughout the microporous material. On a coating-free, printing ink-free, impregnant-free, and pre-bonding basis, pores constitute at least 5 percent by volume of the microporous material, such as at least 10 percent by volume, or at least 15 percent by volume of the microporous material. The pores can constitute from 10 to 80 percent by volume of the microporous material, such as from 10 to 75 percent by volume, or from 10 to 50 percent by volume of the microporous material. As used herein and in the claims, the porosity (also known as void volume) of the microporous material, expressed as percent by volume, is determined according to the equation:

Porosity=100[1−d₁/d₂]

where d₁ is the density of the sample which is determined from the sample weight and the sample volume as ascertained from measurements of the sample dimensions and d₂ is the density of the solid portion of the sample which is determined from the sample weight and the volume of the solid portion of the sample. The volume of the solid portion of the same is determined using a Quantachrome stereopycnometer (Quantachrome Corp.) in accordance with the accompanying operating manual.

The volume average diameter of the pores of the microporous material may be determined by mercury porosimetry using an Autopore III porosimeter (Micromeretics, Inc.) in accordance with the accompanying operating manual. Generally on a coating-free, printing ink-free, impregnant-free, and pre-bonding basis the volume average diameter of the pores is in the range of from about 0.02 to about 0.5 micrometer. For some applications, the volume average diameter of the pores can be in the range of from 0.03 to 0.4 micrometer, or from 0.04 to 0.2 micrometer.

In view of the possibility that some coating processes, printing processes, impregnation processes and/or bonding processes can result in filling at least some of the pores of the microporous material and since some of these processes irreversibly compress the microporous material, the parameters in respect of porosity, volume average diameter of the pores, and maximum pore diameter are determined for the microporous material prior to application of one or more of these processes. In the preparation of the microporous material of the present invention, filler particles, components of the polymeric matrix, and any processing additives such as plasticizers, etc., are mixed until a substantially uniform mixture is obtained. The weight ratio of filler to polymer employed in forming the mixture is essentially the same as that of the microporous material to be produced.

In certain embodiments of the invention, the microporous material may be formed into a sheet having opposing first and second surfaces. In the preparation of a sheet, the mixture may be introduced to the heated barrel of a screw extruder. Attached to the extruder typically is a sheeting die. A continuous sheet formed by the die can be forwarded to a pair of heated calendar rolls acting cooperatively to form a continuous sheet of lesser thickness than the continuous sheet exiting from the die. The final thickness of the sheet can be less than 20 mils (508 microns), and may range from 1 to 10 mils (25 to 254 microns), such as from 3 to 7 mils (76 to 178 microns). The continuous sheet from the calendar may then pass to a take-up roll.

The process for making the microporous sheet is described in more detail in U.S. Pat. No. 5,196,262 at column 7, line 52, to column 8, line 47, the cited portions of which are incorporated herein by reference.

For some end-use applications, the microporous sheet can be stretched to decrease sheet thickness as well as to increase the void volume of the material and to induce regions of molecular orientation in the polymer matrix. As is well known in the art, many physical properties of molecularly oriented organic polymer, including tensile strength, tensile modulus, Young's modulus, and the like, can differ considerably from those of the corresponding organic polymer having little or no molecular orientation. Suitable stretching equipment, methods and parameters are described in detail in U.S. Pat. No. 4,877,679 at column 9, line 19, to column 11, line 32, the cited portions of which are incorporated by reference herein.

The microporous material, either in the form of unstretched sheet or stretched sheet, may alternatively be further processed as desired. Examples of such further processing steps include reeling, cutting, stacking, treatment to remove residual processing additives, and fabrication into shapes for various end uses.

The microporous material of the present invention is capable of maintaining its shape and supporting any subsequently applied layers. The material is exceptionally stiff and strong, and can demonstrate a strength at 1% strain of up to 8000 kPa, such as up to 6000 kPa, or up to 5000 kPa. Also, the material of the present invention can demonstrate a strength at 1% strain of at least 1200 kPa, or at least 1800 kPa, or at least 2000 kPa, or at least 2200 kPa, or at least 2400 kPa. The strength at 1% strain can range between any of the previously stated values, inclusive of those values. In an embodiment of the invention, the strength of the microporous material of the present invention is at least 2400 kPa. For purposes of the present invention, the strength at 1% strain is determined by ASTM D 828-97 (reapproved 2002) modified by using a sample crosshead speed of 5.08 cm/minute until 0.508 cm of linear travel speed is completed, at which time the crosshead speed is accelerated to 50.8 cm/second, and, where the sample width is approximately 1.2 cm and the sample gage length is 5.08 cm.

The microporous material further demonstrates a stiffness of greater than 1.0 g/micron, such as from 1.1 to 5.0 g/micron, or from 1.2 to 3.0 g/micron, as determined by the Handle-O-Meter Stiffness Test described herein in detail in the following examples.

The present invention further provides a multi-layer article comprising (1) a sheet having opposing first and second surfaces, the sheet comprising a microporous material as described above; and (2) an adhesive composition applied over at least a portion of at least one of the first and second surfaces of the sheet. In the preparation of such multilayer articles, the microporous material sheet may be in the unstretched or unstretched form.

Many adhesives which are well known may be used in the articles of the present invention. Examples of suitable classes of adhesives can include curable adhesives, thermosetting adhesives, thermoplastic adhesives, adhesives which form a bond by solvent evaporation, adhesives which form a bond by evaporation of liquid nonsolvent, and pressure sensitive adhesives.

The adhesive composition may be applied to the sheet as a coating using any method conventional to coatings such as spray applying, roll coating, knife blade application, draw bar application, immersion, and the like. Alternatively, the adhesive may be applied as a solid film and laminated or pressure applied to the microporous sheet. In a particular embodiment of the present invention, the adhesive comprises a pressure-sensitive adhesive with removable release films to aid application of the article to other substrates.

The thickness of the adhesive layer may vary widely, depending upon the adhesive type, the desired multilayer construct and/or the end-use application requirements for the multilayer article.

The multi-layer article of the present invention may further comprise additional layers applied on one or both of the component layers (1) and (2). Non-limiting examples can include removable protective films to protect the article from scratching and other damage during transport and handling. In a particular embodiment of the invention, the multi-layer article comprises an adhesive composition over at least a portion of the first surface of the microporous sheet, and a protective layer over at least a portion of the second surface of the sheet. The protective layer may be in the form of a protective coating and/or a film.

Various non-limiting embodiments disclosed herein are illustrated in the following non-limited examples.

### EXAMPLES

In Part 1 of the following examples, the materials and methods used to prepare the Control and Example mixes presented in Table 1 are described. In Part 2, the methods used to extrude, calendar and extract the sheets prepared from the mixes of Part 1 are described. In Part 3, the methods used to determine the physical properties reported in Table 2 are described. In Part 4, a scale-up of the procedure described in Part 2 was used. The materials used in the Scale-up Control and Examples 8 and 9 are listed in Table 3 as percentages of the total mix. The physical properties presented in Table 4 include as a commercial Comparative Example, ARTISYN synthetic paper available from Daramic, LLC., Owensboro, Ky.

### Part 1—Mix Preparation

The dry ingredients were weighed into a FM-130D Littleford plough blade mixer with one high intensity chopper style mixing blade in the order and amounts (grams (g)) specified in Table I. The dry ingredients were premixed for 15 seconds using the plough blades only. The process oil was then pumped in via a hand pump through a spray nozzle at the top of the mixer, with only the plough blades running. The pumping time for the examples varied between 45-60 seconds. The high intensity chopper blade was turned on, along with the plough blades, and the mix was mixed for 30 seconds. The mixer was shut off and the internal sides of the mixer were scrapped down to insure all ingredients were evenly mixed. The mixer was turned back on with both high intensity chopper and plough blades turned on, and the mix was mixed for an additional 30 seconds. The mixer was turned off and the mix dumped into a storage container.

TABLE 1

| | | Example No. | | | | | | |
|---|---|---|---|---|---|---|---|---|
| Ingredients | CONTROL | Ex. 1 | Ex. 2 | Ex. 3 | Ex. 4 | Ex. 5 | Ex. 6 | Ex. 7 |
| Silica (a) | 6810 | 1703 | 1703 | 2270 | 1703 | 1703 | 2270 | 2270 |
| CaCO₃ (b) | 0 | 568 | 568 | 0 | 568 | 568 | 0 | 0 |
| TiO₂ © | 273 | 91 | 91 | 91 | 91 | 91 | 91 | 80 |
| UHMWPE (d) | 1893 | 236 | 236 | 355 | 355 | 355 | 473 | 324 |
| HDPE (e) | 1893 | 236 | 236 | 355 | 355 | 0 | 473 | 162 |
| Polypropylene (f) | 0 | 1419 | 1419 | 709 | 709 | 1064 | 946 | 649 |
| Antioxidant (g) | 45.9 | 15.3 | 15.3 | 15.3 | 15.3 | 15.3 | 15.3 | 15.3 |
| Lubricant (h) | 68.1 | 22.7 | 22.7 | 227 | 22.7 | 22.7 | 22.7 | 22.7 |
| Process oil (i) | 11431 | 3511 | 3511 | 3124 | 3124 | 3124 | 3511 | 2891 |
| Modified PE (j) | 0 | 0 | 0 | 0 | 0 | 0 | 0 | 486 |
| Nano clay (k) | 0 | 0 | 0 | 0 | 0 | 0 | 0 | 0 |

(a) HI-SIL ® 135 precipitated silica was used and was obtained commercially from PPG Industries, Inc.
(b) Calcium carbonate..
(c) TIPURE ® R-103 titanium dioxide, obtained commercially form E.I. du Pont de Nemours and Company.
(d) GUR ® 4130 Ultra High Molecular Weight Polyethylene (UHMWPE), obtained commercially from Ticona Corp.
(e) FINA ® 1288 High Density Polyethylene (HDPE), obtained commercially from Total Petrochemicals.
(f) Polypropylene homopolymer used was PRO-FAX 6823 which has a Melt Mass-Flow Rate (MFR) of 0.5 g/10 min. MFR was reported as done according to ASTM D1238. The material was obtained commercially from Ashland Distribution.
(g) CYANOX ® 1790 antioxidant, Cytec Industries, Inc.
(h) Calcium stearate lubricant, technical grade.
(i) TUFFLO ® 6056 process oil, obtained commercially from PPC Lubricants.
(j) EPOLENE ® G-2608 polymer reported to be a maleic anhydride grafted polyethylene obtained commercially from Eastman.
(k) CLOISITE ® 20A is reported to be a natural montmorillonite modified with a quaternary ammonium salt, obtained commercially from Southern Clay Products.

### Part 2—Extrusion, Calendering and Extraction

The mixes of the Examples and Control were extruded and calendered into final sheet form using an extrusion system including a feeding, extrusion and calendering system described as follows. A gravimetric loss in weight feed system (K-tron model #K2MLT35D5) was used to feed each of the respective mixes into a 27 mm twin screw extruder (model #was Leistritz Micro-27gg). The extruder barrel was comprised of eight temperature zones and a heated adaptor to the sheet die. The extrusion mixture feed port was located just prior to the first temperature zone. An atmospheric vent was located in the third temperature zone. A vacuum vent was located in the seventh temperature zone.

The mix was fed into the extruder at a rate of 90 g/minute. Additional processing oil also was injected at the first temperature zone, as required, to achieve the desired total oil content in the extruded sheet. The oil contained in the extruded sheet (extrudate) being discharged from the extruder is referenced herein as the “extrudate oil weight percent”.

Extrudate from the barrel was discharged into a 15-centimeter wide sheet Masterflex® die having a 1.5 millimeter discharge opening. The extrusion melt temperature was 203-210° C. and the throughput was 7.5 kilograms per hour.

The calendering process was accomplished using a three-roll vertical calendar stack with one nip point and one cooling roll. Each of the rolls had a chrome surface. Roll dimensions were approximately 41 cm in length and 14 cm in diameter. The top roll temperature was maintained between 135° C. to 140° C. The middle roll temperature was maintained between 140° C. to 145° C. The bottom roll was a cooling roll wherein the temperature was maintained between 10-21° C. The extrudate was calendered into sheet form and passed over the bottom water cooled roll and wound up.

A sample of sheet cut to a width up to 25.4 cm and length of 305 cm was rolled up and placed in a canister and exposed to hot liquid 1,1,2-trichloroethylene for approximately 7-8 hours to extract oil from the sheet sample. Afterwards, the extracted sheet was air dried and subjected to test methods described hereinafter.

### Part 3—Testing and Results

Physical properties measured on the extracted and dried films and the results obtained are listed in Table 2. Tensile strength at 1% strain and maximum elongation were tested in accordance with ASTM D 828-97 (reapproved 2002) modified by using a sample crosshead speed of 5.08 cm/minute until 0.508 cm of linear travel speed is completed, at which time the crosshead speed is accelerated to 50.8 cm/second, and, where the sample width is approximately 1.2 cm and the sample gage length is 5.08 cm. Property values indicated by MD (machine direction) were obtained on samples whose major axis was oriented along the length of the sheet. CD (cross machine direction) properties were obtained from samples whose major axis was oriented across the sheet. The aforementioned ASTM test method is incorporated herein by reference.

Handle-O-Meter Stiffness was measured on a Handle-O-Meter, instrument available from Thwing-Albert Instrument Company. Two 4×4 inch (10.16×10.16 cm) specimens were cut from samples of the sheets prepared as described in Part 2. The machine direction was noted for each sample sheet. The first specimen was inserted in the machine direction under the penetrator beam covering the gap in the specimen platform and aligned with the corresponding line on the specimen platform. The test mode was set to single and the beam size was 1000 g. The load reading was zeroed. The peak load, measured as grams (g), was noted as value 1 and the sample was turned 180 degrees and retested to determine value 2. This test procedure was repeated for a second specimen cut from the same sample. The resulting two values from specimen 1 and the two values from specimen 2 were added together and then divided by four to yield an arithmetic average Handleometer value for the sample.

Both extrudate oil weight percent and final product oil weight percent were measured using a Soxhlet extractor, except that the extrudate oil weight percent determination used a specimen of extrudate sheet with no prior extraction, whereas the final product oil weight percent determination used a specimen of already extracted sheet as detailed in Part 2—Extrusion, Calendering and Extraction. In both cases, a sample specimen approximately 2.25×5 inches (5.72 cm×12.7 cm) was weighed and recorded to four decimal places. Each specimen was then rolled into a cylinder and placed into a Soxhlet extraction apparatus and extracted for approximately 30 minutes using trichloroethylene (TCE) as the solvent. The specimens were then removed and dried. The extracted and dried specimens were then weighed. Both oil weight percentage values (extrudate and final product) were calculated as follows: Oil Wt. %=(initial wt.−extracted wt.)×100/initial wt.

Thickness was determined using an Ono Sokki thickness gauge EG-225. Two 4.5×5 inch (11.43 cm×12.7 cm) specimens were cut from each sample and the thickness for each specimen was measured in nine places (at least ¾ of an inch (1.91 cm) from any edge). The arithmetic average of the readings was recorded in mils to 2 decimal places and converted to microns.

The density of the Examples was determined by dividing the average anhydrous weight of two specimens measuring 4.5×5 inches (11.43 cm×12.7 cm) that were cut from each sample by the average volume of those specimens. The average volume was determined by boiling the two specimens in deionized water for 10 minutes, removing and placing the two specimens in room temperature deionized water, weighing each specimen suspended in deionized water after it has equilibrated to room temperature and weighing each specimen again in air after the surface water was blotted off. The average volume of the specimens was calculated as follows:

Volume(avg.)=[(weight of lightly blotted specimens weighed

in air−sum of immersed weights)×1.002]/2

### The anhydrous weight was determined by weighing each of the two specimens on an analytical balance and multiplying that weight by 0.98 since it was assumed that the specimens contained 2 percent moisture.

TABLE 2

| Property | Control | Ex. 1 | Ex. 2 | Ex. 3 | Ex. 4 | Ex. 5 | Ex. 6 | Ex. 7 |
|---|---|---|---|---|---|---|---|---|
| Sheet | 135 | 158 | 147 | 162 | 154 | 138 | 141 | 147 |
| Thickness | | | | | | | | |
| (μm) | | | | | | | | |
| Extrudate Oil | 60.2 | 57.8 | 62.0 | 51.7 | 52.3 | 53.4 | 52.3 | 57.0 |
| wt. % | | | | | | | | |
| Final Product | 6.9 | 4.6 | 11.2 | 6.0 | 5.0 | 5.0 | 7.3 | 11.9 |
| Oil Wt. % | | | | | | | | |
| Density (g/cc) | 0.59 | 0.88 | 0.78 | 0.77 | 0.83 | 0.84 | 0.77 | 0.86 |
| MD Stress @ | 772 | 3399 | 1627 | 2179 | 2834 | 2434 | 2717 | 1326 |
| 1% strain | | | | | | | | |
| (kPa) | | | | | | | | |
| CD Stress @ | 938 | 3647 | 1558 | 2268 | 2999 | 1910 | 2530 | 1988 |
| 1% strain | | | | | | | | |
| (kPa) | | | | | | | | |
| MD Stress @ | 5399 | 8136 | 6129 | 6088 | 7453 | 7750 | 9529 | 17684 |
| Max. strain | | | | | | | | |
| (kPa) | | | | | | | | |
| CD Stress @ | 4089 | 7598 | 4730 | 5743 | 6233 | 5274 | 6943 | 6359 |
| Max. strain | | | | | | | | |
| (kPa) | | | | | | | | |
| Handle- | 0.69 | 1.72 | 1.12 | 1.51 | 1.37 | 1.25 | 1.85 | — |
| o-meter | | | | | | | | |
| Stiffness (g/μm) | | | | | | | | |

### Part 4—Scale-Up Examples

Examples 8 and 9 as well as a Scale-up Control were prepared in a plant scale-up batch size using production scale equipment using similar to the equipment and procedures described above in Part 2. The scale-up samples were prepared from a mix of ingredients listed in Table 3 below as the weight percent of the total mix.

TABLE 3

| | SCALE-UP | | |
|---|---|---|---|
| INGREDIENTS | CONTROL | Example 8 | Example 9 |
| Silica (a) | 30.3 | 25.5 | 22.8 |
| CaCO₃ (b) | 0 | 8.5 | 7.6 |
| TiO₂ © | 1.3 | 1.4 | 1.3 |
| UHMWPE (d) | 8.7 | 4.9 | 5.4 |
| HDPE (e) | 8.7 | 4.9 | 5.4 |
| Polypropylene(f) | 0 | 9.8 | 10.9 |
| Antioxidant (g) | 0.2 | 0.2 | 0.3 |
| Lubricant (h) | 0.3 | 0.4 | 0.4 |
| Process oil (i) | 50.5 | 44.3 | 46.0 |

The mixes of the Scale-up Control and Examples 8 and 9 were extruded and calendered into final sheet form using an extrusion system and oil extraction process that was a production sized version of the system described in Part 2, carried out as described in U.S. Pat. No. 5,196,262, at column 7, line 52, to column 8, line 47, as mentioned above. The final sheets were tested for physical parameters using the test methods described above in Part 3. The results listed in Table 4 below also included as a commercial Comparative Example, ARTISYN® synthetic paper.

TABLE 4

| | | | | Commercial |
|---|---|---|---|---|
| | Scale-up | | | Comparative |
| Property | Control | Example 8 | Example 9 | Example |
| Sheet | 182 | 182 | 132 | 241 |
| Thickness | | | | |
| (μm) | | | | |
| Extrudate Oil | About 58 | About 59 | About 52 | — |
| wt. % | | | | |
| Density (g/cc) | 0.69 | 0.87 | 0.90 | — |
| MD Stress @ | 1851 | 3208 | 4593 | 2093 |
| 1% strain | | | | |
| (kPa) | | | | |
| CD Stress @ | 2086 | 3117 | 5015 | 2368 |
| 1% strain | | | | |
| (kPa) | | | | |
| MD Stress @ | 9286 | 13306 | 21799 | 12131 |
| Max. strain | | | | |
| (kPa) | | | | |
| CD Stress @ | 5121 | 6482 | 9076 | 7129 |
| Max. strain | | | | |
| (kPa) | | | | |

The data presented above in Table 4, illustrate that the same trends for stress at 1% strain are observed for scale-up batches of the microporous sheet prepared in accordance with the present invention on plant-scale equipment as are shown above for lab-scale batches of the microporous sheet prepared in accordance with the present invention. Further, the values for stress at 1% strain for the microporous sheet prepared in accordance with the present invention are superior to those measured for the sheet of the commercial Comparative Example.

Whereas particular embodiments of this invention have been described above for purposes of illustration, it will be evident to those skilled in the art that numerous variations of the details of the present invention may be made without departing from the invention as defined in the appended claims.

1. A microporous material in the form of a microporous sheet having opposing first and second surfaces, the material comprising:
(a) a polymeric matrix component comprising
(i) 5 to 100 weight percent based on total weight of component (a) of low melt flow index polypropylene;
(ii) 0 to 90 weight percent based on total weight of component (a) of ultrahigh molecular weight polyethylene; and
(iii) 0 to 90 weight percent based on total weight of component (a) of high density polyethylene;
(b) a finely divided, particulate filler component dispersed throughout the polymeric matrix (a) comprising inorganic filler materials; and
(c) a network of interconnecting pores communicating substantially throughout the microporous material, the pores constituting 10 to 80 percent by volume of the microporous material, wherein the weight ratio of filler component (b) to polymeric matrix component (a) ranges from 0.1 to 10.0,
wherein the sheet has a thickness ranging from 3 to 8 mils (76.2 to 203.2 micrometers).

2. The microporous material of claim 1, wherein the filler component (b) comprises siliceous and/or non-siliceous filler materials.

3. The microporous material of claim 2, wherein the filler component (b) comprises water-insoluble siliceous materials, metal oxides and/or metal salts.

4. The microporous material of claim 1, wherein the polymeric matrix component (a) further comprises functionalized polyolefin polymer.

5. The microporous material of claim 4, wherein the functionalized polyolefin polymer comprises vinyl acetate and/or vinyl alcohol modified polyethylene, vinyl acetate and/or vinyl alcohol modified polypropylene, copolymers of ethylene and/or propylene modified with acrylic acid, copolymer of ethylene and/or propylene modified with methacrylic acid, maleic anhydride modified polypropylene, and/or maleic anhydride modified polyethylene.

6. The microporous material of claim 1, wherein the filler component (b) comprises siliceous materials comprising silica, mica, montmorillonite, kaolinite, talc, and/or diatomaceous earth

7. The microporous material of claim 4, wherein the filler component (b) comprises siliceous materials comprising silica, mica, montmorillonite, kaolinite, talc, and/or diatomaceous earth

8. The microporous material of claim 5, wherein the filler component (b) comprises siliceous materials comprising silica, mica, montmorillonite, kaolinite, talc, and/or diatomaceous earth.

9. The microporous material of claim 1, wherein the filler component (b) comprises non-siliceous filler material comprising titanium oxide, zinc oxide, , zirconia, calcium carbonate and/or magnesium oxide.

10. The microporous material of claim 1, wherein the low melt flow index polypropylene (i) has a melt flow index ranging from 0.1 to 30 grams/10 minutes.

11. The microporous material of claim 10, wherein the low melt flow index polypropylene (i) has a melt flow index ranging from 0.2 to 5.0 grams/10 minutes.

12. The microporous material of claim 1, wherein the low melt flow index polypropylene (i) is present in the polymeric matrix (a) in an amount ranging from 10 to 90 weight percent based on total weight of matrix (a).

13. The microporous material of claim 1, wherein the ultrahigh molecular weight polyethylene (ii) is present in the polymeric matrix (a) in an amount ranging from 5 to 80 weight percent based on total weight of matrix (a).

14. The microporous material of claim 1, wherein the high density polyethylene (iii) is present in matrix (a) in an amount ranging from 5 to 80 weight percent based on total weight of matrix (a).

15. (canceled)

16. (canceled)

17. The microporous material of claim 1, having a strength at 1 % strain of 1000 to 5000 kPa.

18. The microporous material of claim 1 having a strength at 1% strain of at least 2400 kPa.

19. The microporous material of claim 1, having a stiffness of greater than 1.0 g/micron.

20. The microporous material of claim 19, wherein the polymeric matrix component comprises:
(i) 5 to 50 weight percent based on total weight of the polymeric matrix component of low melt flow index polypropylene;
(ii) 25 to 75 weight percent based on total weight of the polymeric matrix component of ultra high molecular weight polyethylene; and
(iii) 25 to 75 weight percent based on total weight of the polymeric matrix component of high density polyethylene.

21. The microporous material of claim 1, wherein the weight ratio of filler component (ii) to polymeric matrix component (i) ranges from 0.1 to 5.0.

22. A multi-layer article comprising
(1) a sheet having opposing first and second surfaces, the sheet comprising a microporous material comprising:
(A) a polymeric matrix component comprising 5 to 100 weight percent based on total weight of component (A) of low melt flow index polypropylene;
0 to 90 weight percent based on total weight of component (A) of ultrahigh molecular weight polyethylene; and
0 to 90 weight percent based on total weight of component (A) of high density polyethylene;
(B) a finely divided, particulate filler component dispersed throughout the polymeric matrix (A) comprising siliceous and non-siliceous materials; and
(C) a network of interconnecting pores communicating substantially throughout the microporous material, the pores constituting 10 to 80 percent by volume of the microporous material, wherein the weight ratio of filler component (B) to polymeric matrix component (A) ranges from 0.1 to 10.0; and
(2) an adhesive composition applied over at least a portion of at least one of the first and second surfaces of the sheet.

23. The multi-layer article of claim 22, wherein the adhesive composition comprises a pressure sensitive adhesive composition.

24. The multi-layer article of claim 22, comprising an adhesive composition over at least a portion of the first surface of the sheet, and a protective layer over at least a portion of the second surface of the sheet.

25. The multi-layer article of claim 24, wherein the protective layer comprises a protective coating and/or a protective film.

26. The multi-layer article of claim 22, wherein the sheet (1) has a stiffness of greater than 1.0 g/micron.

27. The multi-layer article of claim 22, wherein the polymeric matrix comprises:
(i) 10 to 90 weight percent based on total weight of the polymeric matrix component of low melt flow index polypropylene;
(ii) 5 to 80 weight percent based on total weight of the polymeric matrix component of ultra high molecular weight polyethylene; and
(iii) 5 to 80 weight percent based on total weight of the polymeric matrix component of high density polyethylene.

28. The multilayer article of claim 22, wherein the microporous material has a strength at 1% strain of at least 2400 kPa.

29. The microporous material of claim 1, wherein the polymeric matrix component comprises:
(i) 5 to 50 weight percent based on total weight of the polymeric matrix component of low melt flow index polypropylene;
(ii) 10 to 70 weight percent based on total weight of the polymeric matrix component of ultra high molecular weight polyethylene; and
(iii) 5 to 80 weight percent based on total weight of the polymeric matrix component of high density polyethylene.
